(19) United States
(12) Patent Application Publication
(10) Pub. No.: US 2015/0050622 A1
(43) Pub. Date: Feb. 19, 2015

(54) 3D SCENARIO RECORDING WITH WEAPON EFFECT SIMULATION

(71) Applicant: Rheinmetall Defence Electronics GmbH, Bremen (DE)

(72) Inventor: Klaus Wendt, Sottrum (DE)

(73) Assignee: Rheinmetall Defence Electronics GmbH, Bremen (DE)

(21) Appl. No.: 14/386,370

(22) PCT Filed: Apr. 26, 2013
(86) PCT No.: PCT/EP2013/058721

§ 371 Date: Sep. 19, 2014

(30) Foreign Application Priority Data
Apr. 27, 2012 (DE) 10 2012 207 112.1

(51) Int. Cl. G09B 9/00; F42B 8/26

(52) U.S. Cl. CPC G09B 9/003; F42B 8/26
USPC 434/16

(57) ABSTRACT

Disclosed is a method for the three-dimensional scenario recording of the action taking place during training exercises of firefights at close range, in which multiple, synchronized imaging systems (IS), such as video cameras, scanners or the like, are installed for monitoring the training areas, wherein software calculates from the IS recordings a photo-realistic 3D model of the scenario and records the action continuously as a 3D scenario, detects persons, weapons and other items of equipment (for example protective clothing) and further processes and reproduces them with their anatomical, ballistic, material-typical and optical features as an object module in the 3D model, detects the position and orientation of weapons and the firing thereof, calculates the line of flight of projectiles and replicates them in the 3D model, and, in the case of persons hit by projectiles, calculates the effect of the weapon on the basis of the position of the hit, possibly detected protective clothing.

The invention relates to a method and to an apparatus for the three-dimensional scenario recording of the action taking place during training exercises of firefights at close range, in which multiple synchronized imaging systems (IS), such as video cameras, scanners, infrared cameras or the like, are installed for monitoring the training area.

During training exercises of the military and the police using weapons at a close range in relation to opponents, such as for example inside buildings, vehicles or other close ranges, training munition with marking paint projectiles is frequently used in order to realistically but harmlessly represent weapons and their effects. Those taking part in the training exercises must here wear complicated protective clothing, such as goggles, helmets and armor, which does not correspond to real scenarios. A risk of injury additionally remains on account of the high movement energy of the paint projectiles. Other systems use light transmitters on the weapons, which additionally require corresponding sensors mounted on the opponent, which considerably change weapons in terms of form and center of mass and no longer permit use of the familiar holster. Furthermore, the technology frequently results in negative (confusing) training if, in the case of a hit, no sensor is present at the affected location. This is rectified by beam expansion of the infrared beam. However, this also results in inaccuracies and possibly erroneous indications of hits even if the target was missed.

Weapons such as hand grenades are represented accordingly by spraying paint during the explosion, wherein participants, apparatus and spaces undergo considerable soiling. Even the alternative of emitting light waves and/or radio waves requires corresponding sensor means mounted on the participants. In both technologies, the realism of the training exercise is distorted if items or people are covered by objects which otherwise would have no influence on the weapon effect, such as tables or curtains, and consequently are not struck by the paint or the light waves or radio waves. There is the additional risk that radio waves penetrate objects which, during a real scenario, have protective action, such as for example walls.

In order to view and/or review the action taken during the training exercises for subsequent analysis, the action is recorded in the case of known systems using cameras in the individual spaces or regions and subsequently replayed. Perspective and viewing angle are here specified by the way the camera is mounted and cannot be changed subsequently. Rapid tracking of the action which frequently plays out quickly through several spaces or regions is complicated since corresponding film sequences from various cameras must be strung together such that they fit.

To represent the tactical maneuvers during viewing and reviewing, participants and spaces may be provided with instruments, for example with transponders, beacons or ground sensors, such that the position of persons inside the space can be determined and the weapon use (for example with lines of fire) can be illustrated. For graphic representation, however, the training environment must previously be simulated manually as a contour or a 3D model so that the training data can accordingly be overlaid.

The invention is therefore based on the object of providing a method and an apparatus for the three-dimensional scenario recording of the action taking place during training exercises of firefights at close range, wherein if possible the participants and the training environment are not provided with instruments and the training weapons are not modified. Use of weapons, lines of fire and weapon effects should nevertheless be represented accurately. Reviewing and viewing of the action taking place during training exercises should be possible from any desired perspectives.

These objects are achieved by the features listed in claim 1 and in claim 16.

Use of weapons, lines of fire and weapon effects of the participants are detected automatically using the system according to the invention, the effect is calculated in the case of persons who have been hit using an anatomy model. If training munition is used without projectiles, it is possible without danger to shoot with known original weapons adapted to training munition. No further modification of the weapons or additional equipment items or protective clothing are necessary. Exploding training hand grenades are also detected and their effects calculated.

The invention also makes it possible for the action to be observed in three-dimensional form from any desired perspective in space. When reviewing the action, the scenario recording can be paused, forwarded and rewound as desired or played in slow motion.

The dependent claims 2 to 15 contain various advantageous embodiments of a method according to the invention.

According to one particularly advantageous embodiment of the invention, a person who has been hit is informed via an optical or acoustic signal when the image recognition software has detected a weapon effect.

In one embodiment, a tactical 2D position map can be derived from the 3D scenario, if the participants were previously marked uniquely with symbols or numbers. The participants and their actions, such as movements, weapon use or the like can be mapped uniquely on the 2D position map.

In one method as claimed in claim 7, persons outside the training space may also be recorded and be inserted subsequently in to the 3D scenario recording as a 3D model (avatar) for training purposes. It is thus possible for example for a trainer to demonstrate action improvements.

Backlight which disturbs imaging systems (IS) can be avoided either by being automatically compensated for by way of calculation, or by the illumination bodies being switched on and off with the frequency of the image recording of the opposite IS, wherein the IS only ever records an image when the opposite illumination body is switched off.

In one embodiment of the invention, imaging systems (IS) with different modes of operation and spectral sensitivities and illumination elements of corresponding, different spectral emission are used to compensate for cover effects (for example smoke), object corruption or defects in the 3D scenario.

In one method according to the invention as claimed in claim 12, the requirements of the computational power of the software are lowered by initially generating a model of the training spaces without persons but with any furniture items that may be present, such that during the training exercise only the difference in the image change caused by the action needs to be calculated.

In one method as claimed in claim 13, the models of the training spaces without persons can be combined to form a contiguous 3D model.

In one embodiment according to the invention as claimed in claim 14, it is also possible for the observer to enter, using stereoscopic virtual reality goggles, the scenario himself and to observe the action from the view of the participants.

Simpler mounting and better mobility of the system is achieved if, as claimed in claim 15, the imaging systems (IS) and any illumination systems present are operated supported by batteries and the images are wirelessly transmitted to the evaluating computer.

Dependent claims 17 to 19 contain various advantageous embodiments of an apparatus according to the invention.

In one advantageous embodiment of the apparatus, the imaging systems (IS) are mounted on harnesses and rails and connected by cables. This enables simple and precise mounting.

The apparatus as claimed in claim 18 provides daylight color image cameras and/or monochrome night vision cameras as imaging systems (IS).

In one apparatus as claimed in claim 19, white-light or infrared illumination bodies (for example LEDs) for illuminating the scenario are mounted together with the imaging systems (IS) on mounting harnesses.

The invention will be explained in more detail with reference to an exemplary embodiment illustrated in a simplified manner below.

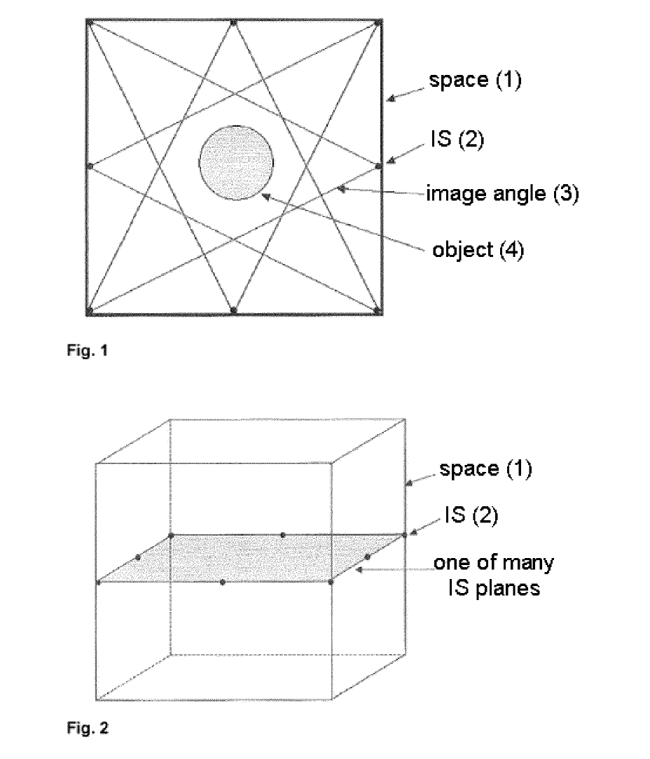

FIG. 1 shows a plan view of one of a plurality of IS planes of the space,

FIG. 2 shows the position of one of a plurality of IS planes in the space,

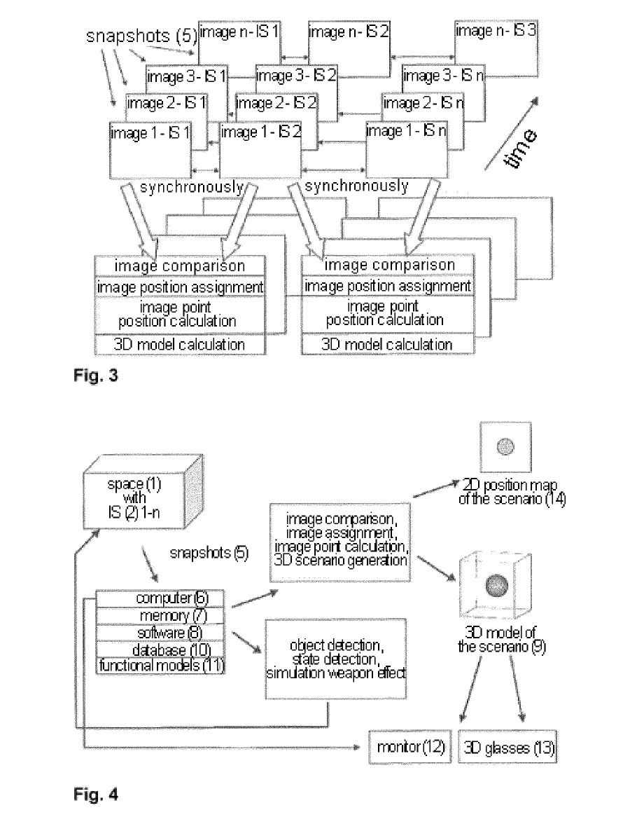

FIG. 3 shows the generation of 3D models from scenario recordings, and

FIG. 4 shows components of the system according to the invention.

In the present exemplary embodiment, the invention is used to carry out a training exercise of a firefight within a space, to record, in the process, the actions taken during the exercise and to enable viewing and reviewing of the action.

A plurality of identical imaging systems (IS) 2, such as for example video cameras, are mounted in space 1, within which the action during the training exercises is to take place. The number of imaging systems (IS) 2, their position and their alignment are selected such that their image angles 3 overlap and as a result the entire space 1 can be observed without gaps. In the present exemplary embodiment, in each case a specific number of IS is suspended in planes which are distributed across the height of the space on all four walls and the ceiling of the space. All IS 2 are synchronized, the frequency of the image recording is identical to all IS 2. In this manner, snapshots 5 of all objects 4 of the scenario from all set-up viewing angles result in the image recording frequency.

All IS are connected to a computer 6, which records said snapshots 5 on a memory 7 and/or processes them online using specialized software 8. The software 8 is capable of comparing the image contents of all recordings taken at the same time and at a specific point in time and of computing a photorealistic 3D model 9 of the scenario from the various perspectives under which the visible image points appear. On account of the synchronized IS, 3D models which are continuously variable according to the action taking place during the training exercises are generated in the image frequency and which can be stitched together into a 3D scenario recording, a 3D film, as it were.

Persons, weapons and equipment items are previously stored as 3D functional models 11 with their anatomical, ballistic, material-typical and optical features in a database 10. The image recognition software 8 is therefore capable of recognizing said objects and their functional states in the image and to incorporate them during the generation of the 3D scenario 9 as an object module. If, for example, the image of a pistol is detected in the action taking place during the training exercise, the breechblock of which moves toward the back, the firing of said weapon is derived therefrom. In the 3D scenario 9, the point of impact of the projectile is computed via the position and the orientation of the weapon in the space 1 and the known ballistic data. In the case of persons who have been hit, the weapon effect is calculated on the basis of their anatomy model and any worn protective clothing which is likewise detected by the image recognition software 8, and communicated for example as an optical and/or acoustic signal to the participants. Hand grenades are also detected, their effect on their environment and any objects in the environment are calculated and communicated.

Moreover, a 2D position map 14 of the training exercise is derived from the 3D scenario 9 of the action. To this end, the participants are marked uniquely with symbols or numbers.

The system according to the invention makes do without providing the participants with instruments and without modifying the training weapons, is accurate in terms of representing the weapon effects and enables viewing and reviewing on one or more monitors 12 from any desired perspectives.

It is additionally possible for the observer using stereoscopic virtual reality goggles 13, or 3D glasses, to enter the scenario himself and to observe the action from the view of the participant.

1. A non-transitory computer readable medium containing program instructions for the three-dimensional scenario recording of the action taking place during training exercises of firefights at close range, in which multiple synchronized imaging systems (IS), such as video cameras, scanners or the like, are installed for monitoring the training areas, wherein execution of the program instructions by a computer causing the computer to perform the method of:
calculates a photorealistic 3D model of the scenario from the recordings of the IS and records the action continuously as a 3D scenario,
detects persons, weapons and other equipment items (for example protective clothing) and further processes and reproduces them with their anatomical, ballistic, material-typical and optical features as an object module in the 3D model,
detects the position and orientation of weapons and the firing thereof, calculates the line of flight of projectiles and maps them in the 3D model, and,
in the case of persons who have been hit by projectiles, calculates the effect of the weapon on the basis of the position of the hit, any detected protective clothing and the ballistic factors.

2. The method as claimed in claim 1, characterized in that the imaging systems (IS) are selected in terms of their number, position and alignment such that their viewing angles overlap and the action in the training spaces is monitored from all perspectives without gaps.

3. The method as claimed in claim 1, characterized in that the imaging systems are all connected to a computer on which the recordings are collected and processed using image recognition software.

4. The method as claimed in claim 1, characterized in that persons who have been hit are informed via an optical and/or an acoustic signal.

5. The method as claimed in claim 1, characterized in that hand grenades are likewise detected as an object module and the effects thereof in the special scenario are calculated.

6. The method as claimed in claim 1, characterized in that a 2D projection (outline of the training space) is generated from the 3D scenario recording, on which the participants and their actions (movements, weapons use, lines of fire or the like) are uniquely mapped.

7. The method as claimed in claim 1, characterized in that one or more persons are recorded even outside the training space by several IS in order to be inserted subsequently into the 3D scenario recording as a 3D model (avatar) for training purposes and as a result for example action improvements can be demonstrated.

8. The method as claimed in claim 1, characterized in that any disturbing backlight of directly visible illumination bodies or other IS in the training space are automatically compensated for by way of calculation.

9. The method as claimed in claim 1, characterized in that any disturbing backlight is avoided by the illumination bodies producing the disturbing backlight being switched on and off with the frequency of the image recording of the opposite IS, wherein the IS only ever records an image when the illumination body is switched off.

10. The method as claimed in claim 1, characterized in that IS with different modes of operation and spectral sensitivities and illumination elements of corresponding, different spectral emission are used to compensate for cover effects (for example smoke), object corruption or defects in the 3D scenario.

11. The method as claimed in claim 1, characterized in that the recordings of the IS are provided and stored with a time stamp.

12. The method as claimed in claim 1, characterized in that initially a model of the training spaces without persons but with any furniture items that may be present is generated, such that during the training exercise only the difference in the image change caused by the action needs to be calculated.

13. The method as claimed in claim 12, characterized in that a plurality of models of training spaces without persons are combined to form a contiguous 3D model, for example to form a house model.

14. The method as claimed in claim 1, characterized in that the observer of the 3D scenario recording has the option of observing the action from the view of the participants using stereoscopic virtual reality goggles.

15. The method as claimed in claim 1, characterized in that the IS and any illumination systems present are operated supported by batteries and the images are wirelessly transmitted to the evaluating computer.

16. An apparatus for carrying out a method as claimed in claim 1, characterized by a plurality of imaging systems (IS) for capturing the action from a plurality of perspectives, a computer having software for calculating the 3D scenario recording from the data of the IS, a database with functional models of persons, weapons and equipment items stored therein, wherein in particular anatomical, ballistic, material-typical and optical features are stored, and at least one monitor for viewing or reviewing the recordings.

17. The apparatus as claimed in claim 16, characterized in that the IS are mounted on harnesses or rails for quick and simple mounting and are connected by cables.

18. The apparatus as claimed in claim 16, characterized in that daylight color image cameras and/or monochrome night vision cameras are used as IS.

19. The apparatus as claimed in claim 15 characterized in that white-light or infrared illumination bodies (for example LEDs) for illuminating the scenario are also mounted on the mounting harnesses of the IS.
